(19) United States
(12) Patent Application Publication
(10) Pub. No.: US 2008/0239948 A1
(43) Pub. Date: Oct. 2, 2008

(54) SPECULATIVE CONGESTION CONTROL SYSTEM AND CROSS-LAYER ARCHITECTURE FOR USE IN LOSSY COMPUTER NETWORKS

(75) Inventors: Haowei Bai, Glendale, AZ (US); David J. Lilja, Maplewood, MN (US)

Correspondence Address: HONEYWELL INTERNATIONAL INC., 101 COLUMBIA ROAD, P O BOX 2245, MORRISTOWN, NJ, 07962-2245, US

(73) Assignee: HONEYWELL INTERNATIONAL, INC., Morristown, NJ (US)

(21) Appl. No.: 11/692,731

(22) Filed: Mar. 28, 2007

(51) Int. Cl. H04L 12/56

(52) U.S. Cl. 370/230

(57) ABSTRACT

Methods and apparatus are provided to improve data throughput in a wireless, wireline or a combination wireless and wireline communication system. A congestion control manager selects between an assumption based congestion control algorithm and a speculation based congestion control algorithm. The selected algorithm generates data recovery instructions including instructions for resizing, or not, congestion window sizing for the communication gateways. By making the selection between the assumption based congestion control algorithm and the speculation based congestion control algorithm based upon network information, data recovery and throughput is optimized for networks having lossy data links.

### FIELD OF THE INVENTION

The present invention generally relates to communication systems, and more particularly relates to communication systems employing congestion control to address lossy information links or information congestion within the communication system.

### BACKGROUND OF THE INVENTION

Contemporary communication systems are designed in a tiered or layered arrangement typically rising from a physical layer to a link layer, then to a network layer above which is a transport layer then a middleware layer to ultimately an application layer; which is the layer users interface with when communicating through the network. Both wireline and wireless communication systems commonly move data in packets to minimize retransmission for dropped or corrupted data packets. A widely deployed wireline network utilizes the Transport Control Protocol (TCP)/Internet Protocol (IP) suite. TCP was originally designed for wireline networks, where packet losses are mostly caused by network congestions. The current TCP algorithm uses either a retransmission timer timing out, or receipt of three duplicate acknowledgements (ACKs) sent by receivers, to implicitly indicate data packet loss events.

However, networks with lossy links, such as radio frequency (RF) wireless networks, have a number of characteristics inherently different from wireline networks, for which the TCP/IP suite was originally designed. Notable among these differences is the transmission error measured by bit error rate (BER). Few errors per packet may be corrected by lower network layer encoding schemes. However, more errors may result in dropped packets. Naturally, dropped packets are not handed up to the application layer, therefore it is the responsibility of transport protocol layer to handle the recovery of dropped packets.

Since the original TCP protocol utilizes a packet loss as an indication of network congestion it can work against efficient data packet throughput when wireless networks are involved in a data packet flow. In a wireless network with lossy links, packet losses due to link errors are not caused by network congestions. Unfortunately, the current TCP protocol treats these losses as congestion losses, and in turn reduces the transmission speed, thus reducing communication throughput.

Unlike wireline TCP/IP networks, wireless links are characterized by high error rates. In most cases, packet losses due to corruption are more significant than congestion losses when a wireless link is involved in a TCP connection. In such a case, TCP may not be able to transmit or receive at the full available bandwidth, because the TCP algorithm will be unnecessarily reducing transmission speed in an attempt to avoid perceived congestion assumed to have been triggered by link errors. Consequently, the current congestion control algorithms in TCP result in very poor performance over wireless links.

Moreover, it is increasingly common for wireless networks to bridge onto classical wireline TCP/IP networks. The resulting patchwork of wireline and wireless networks may never operate at full performance if the TCP/IP algorithm operates to manage congestion over the wirelessly extended network. Also, wireline networks damaged by natural disasters or man made attacks can be rendered lossy and the legacy TCP algorithm will not be able to effectively control congestion.

Accordingly, it is desirable to have a congestion control algorithm for a wireless or combination wireless/wireline communication system that is able to differentiate and respond appropriately in the presence of congestion and corruption losses. In addition, it is desirable to have a communication system congestion management control that is designed to be fair with competing data flows. Moreover, a new congestion control architecture for a communication system should be backward compatible with existing legacy networks, so that it will be easy to integrate such a new system with legacy networks. Furthermore, other desirable features and characteristics of the present invention will become apparent from the subsequent detailed description of the invention and the appended claims, taken in conjunction with the accompanying drawings and this background of the invention.

### BRIEF SUMMARY OF THE INVENTION

An apparatus is provided for efficient data throughput in a wireless or combination wireless and wireline communication system. The apparatus comprises a speculation based congestion control algorithm (denoted SpecTCP) that operates alone or in conjunction with an assumption based congestion control algorithm (for legacy backward compatibility) under the control of a congestion control manager. The algorithm selected by the congestion control manager generates data recovery instructions including instructions for resizing, or not, congestion window sizing for the communication gateways. Application of SpecTCP together with improvements at the middleware and network layers of a communication system combine to provide a cross-layered architecture that optimizes data recovery and throughput in networks having lossy data links.

A method is provided for utilizing a speculation based congestion control algorithm (denoted SpecTCP) alone or in conjunction with an assumption based congestion control algorithm (for legacy system backward compatibility) under the control of a congestion control manager. The algorithm selected by the congestion control manager generates data recovery instructions including instructions for resizing, or not, congestion window sizing for the communication gateways. Application of SpecTCP together with improvements at the middleware and network layers of a communication system combine to provide a cross-layered architecture that optimizes data recovery and throughput in networks having lossy data links.

### BRIEF DESCRIPTION OF THE DRAWINGS

The present invention will hereinafter be described in conjunction with the following drawing figures, wherein like numerals denote like elements, and

FIG. 1 is a block diagram of a communication node arranged within a communication system in accordance with the present invention;

FIG. 2 is a block diagram of the conditional Bernoulli predictor in accordance with the present invention; and

FIG. 3 is a flow diagram of the SpecTCP algorithm in accordance with the present invention.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

To overcome the detriments of legacy congestion control systems when applied to lossy (e.g., wireless) links characterized by high error rates, the present invention has applied speculative techniques (i.e., speculating on the outcome of branch predictions) for throughput improvements when lossy links are involved in TCP/IP connections. The present invention eliminates the waste of bandwidth responding to link errors, using speculative techniques resulting in significantly improved network throughput.

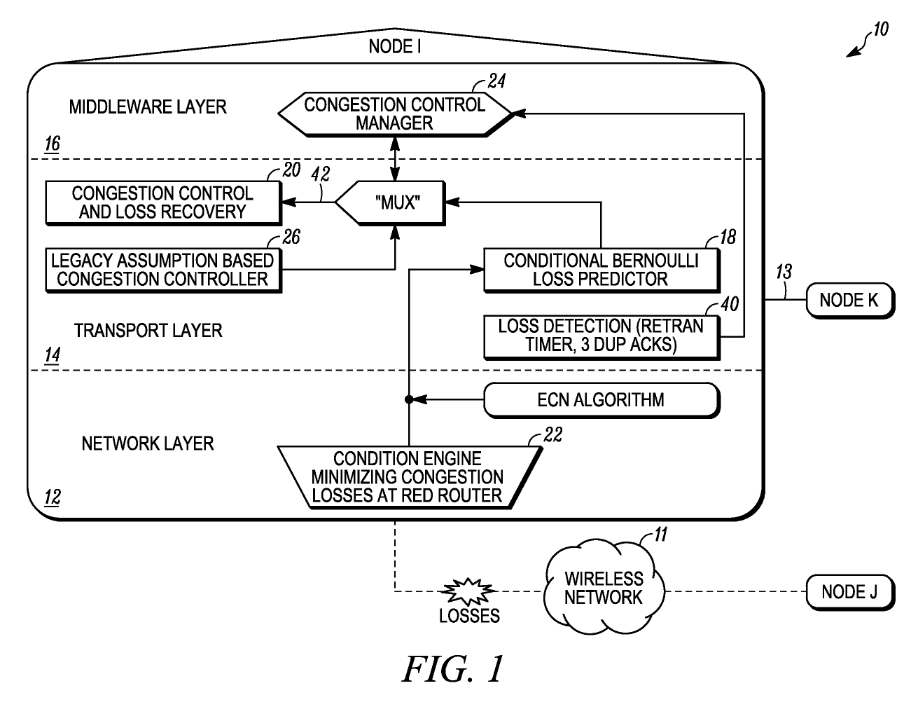

Referring to FIG. 1, a single communication node 10 in accordance with an embodiment of the present invention is illustrated in block diagram form. As can be seen, the communication node 10 of FIG. 1 is arranged in layers (three layers shown); a network layer 12 that interfaces with a link layer (not shown) interfaced with wireless transmitters, receivers or transceivers, a transport layer 14 and a middleware layer 16. Those of ordinary skill in the art will appreciate that above the middleware layer 16, one or more applications would be running as desired by users of the communication system. The communication node 10 of FIG. 1 is particularly useful in wireless communication systems (e.g., radio frequency, infrared and wireless LAN) 11 alone or in combination with a wireline communication system 13. It is also useful in wireline networks damaged by natural disasters or man made attacks can be rendered lossy and the legacy TCP algorithm will not be able to effectively control congestion. Such communication systems may be terrestrial, maritime, avionic or space based communications systems.

In accordance with the preferred embodiment of the present invention, enhancements to all three illustrated layers are made. Enhancements at the middleware layer 16 and the network layer 12 provide control functions and supporting parameters to the transport layer 14. At the transport layer 14, a conditional Bernoulli loss predictor 18 provides inputs to a congestion control and loss recovery module 20. Congestion control and loss recovery module 20 utilizes a speculation based algorithm according to a preferred embodiment of the present invention. Together, the conditional Bernoulli loss predictor 18 and the congestion control and loss recovery module 20 combine to provide SpecTCP congestion control. By providing enhancements on more than one layer of the communication node 10 of FIG. 1, the present invention would be recognized by those skilled in the art as a cross-layer congestion management system for one preferred embodiment of the present invention.

At the network layer 12, a condition engine 22 provides required information for the conditional Bernoulli predictor 18. The condition engine 22 includes mathematical models of explicit congestion notification (ECN) capable random early drop (RED) gateways that produce networking parameters to minimize congestion losses at RED gateways, thus maximizing the accuracy of the conditional Bernoulli loss predictor 18 at the transport layer. To most effectively adjust RED gateway parameters so that congestion losses can be minimized, the present invention utilized mathematical models to dimension the buffer size inside a RED gateway. As dimensioned by the present invention, the RED gateway buffer sizes are much smaller than previously suggested values thus providing a significant contribution to the network performance improvement.

At the middleware layer 16, a congestion control manager 24 is used to select and control the execution of congestion control schemes at the transport layer 14. Based on the global knowledge of a network, the congestion control manager 24 makes and executes the decision whether the communication system should run an assumption based congestion control algorithm of the legacy assumption based congestion controller 26 (i.e., TCP/IP) or SpecTPC (the speculation based congestion control algorithm of the conditional Bernoulli loss predictor 18 and congestion control and loss recovery module 20). Moreover, the congestion control manager 24 at the middleware layer 16 functions as a bridge to ensure that end users with the communication system of the present invention can communicate with users of legacy networks. This is achieved by the ability of switching between the legacy assumption based congestion controller 26 and SpecTCP based upon the global ECN compatibility information obtained through the congestion control manager 24.

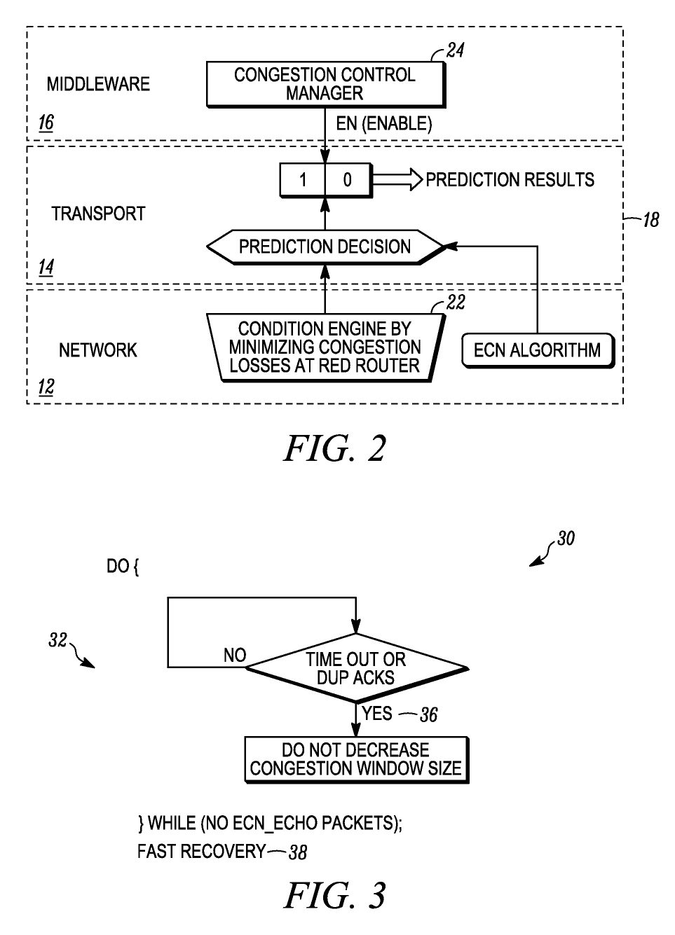

FIG. 2 illustrates the operation of the conditional Bernoulli predictor 18 within the communication node 10 in block diagram form. In order to improve the TCP throughput over lossy links, the preferred embodiment of the present invention utilizes conditional Bernoulli loss predictor 18 to predict the type of loss event, (i.e., congestion loss or link corruption loss), and make the TCP congestion window respond accordingly. Predictive speculation techniques have been used in computer architecture to eliminate potential clock-cycle penalties caused by branch hazards. However, unlike the speculation techniques used in processor design, if the speculations are incorrect, there is no way to undo or flush execution results for the case of TCP congestion control. This is because execution results of instructions in a processor are values of pre-designed calculations, while execution results of the TCP congestion control algorithm are changes (increments or decrements) of the TCP transmission speed. To improve the speculation accuracy the present invention minimizes the probability of congestion losses by optimally dimensioning the buffer of the ECN capable RED gateways in the network. When a RED buffer is optimally dimensioned and the thresholds appropriately set, the probability of congestion losses can be minimized by appropriately adjusting the sender's congestion window size based on feedback from ECN signals.

As illustrated in FIG. 2, the condition engine 22 at the network layer 12 uses congestion loss minimization models at RED gateways to minimize network congestion losses. The output of condition engine 22 is employed so that congestion loss events are minimized. Based on the accuracy of this result, the conditional Bernoulli loss predictor 18 at the transport layer 14 produces results by setting the Bernoulli probability P for predicting link corruption losses, and accordingly the probability of predicting congestion losses is 1−P. If the condition engine 22 is optimized according to the present invention (i.e., congestion losses are minimized), the conditional Bernoulli loss predictor 18 at the protocol layer 14 sets P=1, resulting in predicting incoming loss events as link corruption losses.

To develop the congestion loss minimization models at RED gateways, the inventors derived expressions for the maximum buffer size and the maximum threshold of a RED gateway to minimize congestion packet losses. The minimization of congestion losses significantly improves the accuracy of speculating that loss events are due to link corruptions. This indicates that the condition engine within conditional Bernoulli predictor is optimized. Therefore, it is reasonable to set P=1 (i.e., to predict all incoming loss events are caused by link errors). As is known, ECN-capable RED gateways use an exponential weighted moving average to calculate an average queue size from the instantaneous queue size, and two thresholds (minimum and maximum), to determine whether an arriving packet should be dropped. If the average queue size is greater than the maximum threshold, the packet is dropped. If the average queue size is between the minimum and the maximum thresholds, the packet is marked with a probability as a Congestion Experienced (CE) packet. Packet losses due to the average queue size exceeding the maximum threshold at a RED gateway degrade TCP performance.

Those skilled in the art will be able to consider a typical model consisting of two RED gateways fed by multiple sources. As is known, the link connecting two RED gateways is the bottleneck link which causes congestion. The sources, destinations and the RED gateways use ECN for end-to-end congestion control.

The following notations will be used in the discussion of the inventive model in accordance with the present invention:
Q(t);Q(t)ₘₐₓ: Instantaneous and maximum instantaneous queue sizes respectively at the RED gateway at time t.
Q, Qₘₐₓ: Average and maximum average queue sizes respectively at the RED gateway.
w: Weighting factor for calculating Q.
p(t): Marking probability at the RED gateway at time t.
minₜₕ, maxₜₕ: Minimum and maximum thresholds respectively of a RED gateway.
m: total number of TCP flows.
Wi(t): Window size of the i^{th} TCP flow at time t, t, ≧0, i=1, . . . , m.
SSthreshᵢ: Slow Start threshold for the i^{th} TCP flow,
ri: Round Trip Time (RTT) for the i^{th} TCP flow, i=1; . . . ,m. ri is replaced by r when all the RTTs are same.
μᵢ: Average share of bottleneck link bandwidth of the i^{th} TCP flow, i=1; . . . , m.
μ: Bandwidth of bottleneck link which is given by

$$μ = {\sum }_{i = 1}^{m} {μ}_{i} .$$

T[1]: Waiting time for the first marking event after the average queue size exceeds minₜₕ.
βᵢ: Number of window size increases during time T[1] for the iₜₕ TCP flow, i=1; . . . ,m.
τᵢ: Propagation delay from source i to the RED gateway, i=1; . . . , m.
t₀: Time when the first packet is marked at the RED gateway.
t₁: Time when the last packet, which was sent just before the first window size reduction, arrives at the RED gateway.

Packet drops at an ECN-capable RED gateway are either due to buffer overflows (Q(t) is equal to the buffer size) or Q>maxₜₕ. The congestion window size during the slow start phase increases very quickly. The average queue size (being the output of a low pass filter) of a RED gateway can not follow the quick change of Q(t); as a result Q stays less than minₜₕ. Therefore, Q(t) reaches the maximum value when the packet leaving the source at t−τᵢ reaches the RED buffer. When this packet left the source, Wᵢ(t−τᵢ)=SSthreshᵢ for i=1; 2 . . . ,m; the queue size is smaller when the sources are in congestion avoidance. For m TCP flows, Q(t)ₘₐₓ can be expressed as the output of a system with processing capacity of

$${\sum }_{i = 1}^{m} {r}_{i} {μ}_{i}$$

and the maximum input rate when sources reach their slow start threshold.

Thus:

$$\begin{matrix}{Q ( t )}_{max} = {\sum }_{i = 1}^{m} ( Wi ( t - {τ}_{i} ) - {r}_{i} {μ}_{i} ) \\ = {\sum }_{i = 1}^{m} ( {SSth}_{i} - {r}_{i} {μ}_{i} ) .\end{matrix} \qquad ( Eq 1 )$$

According to one embodiment of the present invention, this is the buffer size used to minimize packet loss at the RED gateway.

Turning now to the derivation of the maximum average queue size, it is known that the recommended maxₜₕ=3×minₜₕ. When the average queue size is in the steady-state condition (during which the sources are in the congestion avoidance phase), the instantaneous queue size at time t₀ is:

$$Q ( {t}_{0} ) = {min}_{th} + {\sum }_{i = 1}^{m} {β}_{i} .$$

Since the difference between t₀ and t₁ is one RTT, and the window size of a source is increased by one per RTT during the congestion avoidance phase, the instantaneous queue size at time t₁ can be expressed as:

$$Q ( {t}_{1} ) = {min}_{th} + {\sum }_{i = 1}^{m} ( {β}_{i} + 1 ) .$$

The average queue size is estimated using an exponential weighted moving average as shown in Eq 1 above. If time is discretized into time slots with each slot being equal to one RTT, the RED's average queue size estimation algorithm at the k-th slot can be expressed as: Q[k+1]=(1−w)Q[k]+Q[k]w. In practice, w is very small, and the congestion window size increases by one every RTT during the congestion avoidance phase. Therefore, before the first marking event happens (i.e., no congestion control) it is reasonable to consider both the instantaneous queue size and the average queue size to be constant within a very short time period. Thus, by using Q(t₁) (slot k is equal to t₁ in time) the derivation above and assuming that the average queue sizes during the two previous consecutive time slots are the same, the average queue size estimated at time t₁ can be solved iteratively, which is:

$${Q}_{max} = Q = {min}_{th} + {\sum }_{i = 1}^{m} ( {β}_{i} + w ) . \qquad ( Eq 2 )$$

The first marking event is followed by many random ECN marking events, which make TCP sources adjust their congestion window sizes. The average queue size stays at a certain level smaller than the average queue size at time t₁. Therefore, Eq 2 gives the maximum average queue size for minimizing packet losses and represents the value of maxₜₕ according to the present invention.

With the buffer size and maximum average queue size determined, consider again FIG. 2. The conditional Bernoulli loss predictor 18 is enabled or disabled by the congestion control manager 24 at the middleware layer 16. For network backward compatibility issues (i.e., some network components may not be ECN capable), the congestion control manager 24 may choose to disable the conditional Bernoulli loss prediction function and switch to the legacy assumption based congestion controller 26. This function is especially useful for integrating networking equipment in accordance with the present invention with existing network infrastructure.

FIG. 3 illustrates the algorithm utilized of SpecTCP (the combination of the conditional Bernoulli loss predictor 18 and congestion control and loss recovery module 20). The algorithm 30 treats the retransmission timer timing out and/or three duplicate acknowledgements as an indication of link errors 32. According to a preferred embodiment of the present invention, this provides the speculation that the losses are due to link corruption. Most often, this is the case in a network with wireless links (data packet losses due to link errors). In this case, the algorithm does not decrease (either not substantially or at all) the congestion window of the RED gateways 34. This assumes that no ECN ECHO packets were received 36 which would indicate that, potentially, there were no congestion data packet losses. If an incorrect speculation/prediction was made (i.e., an ECN ECHO packet was received) then a fast recovery scheme 38 is executed as is known in contemporary TCP algorithms.

In the algorithm 30 in SpecTCP, the congestion window size is appropriately controlled in the presence of either network congestion or corruption. In the preferred embodiment of the present invention, the congestion window is halved with the fast recovery algorithm when there is network congestion (as evidenced by ECN EHCO packets 36) and the congestion window size persists (remains substantially unchanged) at the previous value in the presence of corruption. Alternately, adjusting the congestion window size in the range of 40 percent to 80 percent may also be done, however, about a 50 percent reduction is one preferred embodiment. As will be appreciated by those skilled in the art, the ECN mechanism will be most effective if it is used with active queue management such as that found in contemporary RED gateways. In active queue management, when a buffer reaches a certain threshold, the RED gateway will send a CE packet to the TCP receiver before the buffer overflows. Therefore, packet drops due to congestion happen only after the RED gateway has sent CE packets. By optimally dimensioning the congestion window size per the present invention, and using the maximum threshold for the active queue management for ECN capable RED gateways, the accuracy of the conditional Bernoulli loss predictor 18 can be optimized.

Returning again to FIG. 1, the overall operation of the present invention can be described. First, a loss is detected 40 and the congestion control manager 24 is notified. Loss events are detected by either retransmission timer timing out or three duplicated acknowledgements at the transport layer. Using the global knowledge of the network, such as whether or not the receiver is ECN compatible, the congestion control manager will issue commands about which loss treatment algorithm should be executed. If the receiver and other nodes along the way to the receiver are ECN capable, then the SpecTCP (speculative) algorithm and the conditional Bernoulli loss predictor 18 is applied. Otherwise the legacy assumption based congestion controller 26 is executed. After the congestion control manager 24 chooses the appropriate loss treatment scheme, the selected loss treatment algorithm generates and supplies appropriate congestion window sizing and recovery commands 42 to the congestion control and loss recovery module 20. The congestion control and loss recover module 20 then executes congestion window resizing (or substantially maintaining the current size) in accordance with the loss treatment selected by the congestion control manager 24. In this way, lost or dropped data packets can be most effectively retransmitted.

As will be appreciated by those skilled in the art, the present system architecture of the present invention is effective in improving network throughput over lossy links. The inventive communication system is able to issue correct commands to the congestion control algorithm for different types of loss events. By speculations, the message sender does not have to waste time and bandwidth (i.e., congestion window size backoff) waiting for implicit network information about the losses. The present invention solves the problem of the current TCP incorrectly interpreting link corruption losses as network congestion losses. Therefore, network throughput effectively is enhanced.

Additionally, the communication system of the present invention is able to handle the issue of incorrect speculations. At the network layer 12, minimizing network congestion losses maximizes speculation accuracy. Also, for the small possibility of incorrect speculation, contemporary ECN algorithms are used to provide early explicit congestion signals. Therefore, when the speculation algorithm itself tends to incorrectly speculate a congestion loss (the fact) as a link corruption loss (the speculation result), the actual network congestion will be identified and handled by the ECN algorithm.

Another benefit of the present invention is that it does not starve other competing data flows. Under the normal working condition, no matter which congestion control algorithm is applied, all users are controlled by congestion window evolutions, which was designed to reduce unfairness. Unfairness in data flow is more likely to happen during failure modes of the system. For example, if the communication system incorrectly speculated a congestion loss as a link corruption loss, and ECN packets used to indicate congestions were lost, the system would not decrease the sender's congestion window size (but it should), which could result in starvation of other competing legacy TCP data flow. To improve the ECN algorithm reliability, ECN packets are transmitted continuously until the sender acknowledges that ECN packets are received. This makes the communication system of the present invention backward compatible with legacy networks. The congestion control algorithm manager 24 at the middleware layer 16 functions as a software bridge to ensure that end users with the inventive communication system can communicate with users with legacy networks. This is achieved by the ability of switching between the legacy assumption based congestion controller 26 and the speculative algorithm of the conditional Bernoulli loss predictor 24, based on the global ECN compatibility information obtained through middleware layer.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. A method for controlling congestion in a communication system having a speculation based congestion control architecture, comprising:
predicting whether a lost data packet was due to network congestion or data corruption; and
adjusting a congestion window size when network congestion is predicted.

2. The method of claim 1 which includes the step of not adjusting the congestion window size when data corruption is predicted.

3. The method of claim 1 which includes the step of not substantially adjusting the congestion window size when data corruption is predicted.

4. The method of claim 1 wherein the congestion window size is reduced by fifty percent when network congestion is predicted.

5. The method of claim 1 wherein the congestion window size is reduced by about fifty percent when network congestion is predicted.

6. The method of claim 1 wherein the congestion window size is reduced approximately 40 percent to 80 percent when network congestion is predicted.

7. The method of claim 2 wherein the steps are performed within a transport layer of an ECN compatible cross-layered communication system.

8. A congestion control architecture for use in a communication system, comprising:
means for predicting whether a lost data packet was due to network congestion or data corruption; and
means for adjusting a congestion window size when network congestion is predicted.

9. The architecture of claim 8, including a network layer having a condition engine for generating network parameters to enhance the effectiveness of the predicting means.

10. The architecture of claim 8, including a middleware layer for controlling whether the prediction means and adjusting means will be inactivated in favor of using an assumption based congestion algorithm.

11. The architecture of claim 8, wherein the adjusting means uses a speculation based congestion algorithm.

12. A congestion control system for use in a communication system, comprising:
a conditional Bernoulli loss predictor for predicting whether a lost data packet was due to network congestion or data corruption;
congestion controller having a speculation based congestion algorithm for appropriately adjusting a congestion window size when network congestion or data corruption is predicted; and
a condition engine for generating network parameters to enhance the effectiveness of the conditional Bernoulli loss predictor.

13. A communication system, comprising:
a first layer including a congestion control manager responsive to an indication of a lost data packet to select either a speculation based congestion controller or an assumption based congestion controller;
a second layer including the speculation based congestion controller and the assumption based congestion controller each capable of generating instructions for recovery of the lost data packet including instructions for congestion window sizing; and
a third layer including a condition engine for generating network parameters to enhance the effectiveness of the a speculation based congestion controller.

14. The communication system of claim 13, wherein the assumption based congestion controller utilizes a TCP congestion management algorithm.

15. The communication system of claim 13, wherein the speculation based congestion controller utilizes a conditional Bernoulli loss predictor.

16. The communication system of claim 13, wherein the speculation based congestion controller generates instructions to decrease the congestion window sizing by one-half in the presence of data congestion.

17. The communication system of claim 13, wherein the speculation based congestion controller generates instructions to decrease the congestion window sizing by about one-half in the presence of data congestion.

18. The communication system of claim 13, wherein the speculation based congestion controller generates instructions to decrease the congestion window sizing by about 40 percent to 80 percent in the presence of data congestion.

19. The communication system of claim 13, wherein the speculation based congestion controller generates instructions to not decrease the congestion window sizing in the presence of data corruption.

20. The communication system of claim 13, wherein the third layer comprises a network layer in communication with ECN compatible RED gateways.

21. The communication system of claim 20, wherein the RED gateways utilize active queue management.

22. The communication system of claim 13, wherein the third layer comprises a network layer in communication with wireless communication equipment.

23. The communication system of claim 13, wherein the third layer comprises a network layer in communication with wireline communication equipment.

24. The communication system of claim 13, wherein the third layer comprises a network layer in communication with wireless and wireline communication equipment.

25. A communication system, comprising:
a middleware layer including a congestion control manager responsive to an indication of a lost data packet to select either SpecTCP or a legacy congestion controller;
a transport layer including SpecTCP and the legacy congestion controller each capable of generating instructions for recovery of the lost data packet including instructions for congestion window sizing; and
a network layer including a condition engine for generating network parameters to enhance the effectiveness of the conditional Bernoulli loss predictor.

26. The communication system of claim 25, wherein the legacy congestion controller utilizes a TCP congestion management algorithm.

27. The communication system of claim 25, wherein the speculation based congestion controller generates instructions to decrease the congestion window sizing by one-half in the presence of data congestion.

28. The communication system of claim 25, wherein the speculation based congestion controller generates instructions to decrease the congestion window sizing by about one-half in the presence of data congestion.

29. The communication system of claim 25, wherein the speculation based congestion controller generates instructions to decrease the congestion window sizing by about 40 percent to 80 percent in the presence of data congestion.

30. The communication system of claim 25, wherein the speculation based congestion controller generates instructions to not decrease the congestion window sizing in the presence of data corruption.

31. The communication system of claim 25, wherein the speculation based congestion controller generates instructions to not substantially decrease the congestion window sizing in the presence of data corruption.

32. The communication system of claim 25, wherein the network layer is in communication with ECN compatible RED gateways.

33. The communication system of claim 32, wherein the RED gateways utilize active queue management.

34. The communication system of claim 25, wherein the network layer in communication with wireless communication equipment.

35. The communication system of claim 25, wherein the network layer in communication with wireline communication equipment.

36. The communication system of claim 25, wherein the network layer in communication with wireless and wireline communication equipment.

37. A method for communicating data in a communication system, comprising the steps of:
(a) detecting a data packet loss;
(b) determining whether to utilize a legacy congestion controller or SpecTCP to generate instructions for recovery of the lost data packet including generating instructions for sizing a congestion window;
(c) responsive to step (b), controlling whether and to what extent the congestion window sizing is changed.

38. The method of claim 37, wherein the determination of step (b) is based upon whether ECN compatible RED gateways are present in the communication system.

39. The method of claim 37, wherein the determination of step (b) includes reducing the congestion window sizing by one-half when the conditional Bernoulli loss predictor determines that the data packet was lost due to network congestion.

40. The method of claim 37, wherein the determination of step (b) includes not changing the congestion window sizing when the conditional Bernoulli loss predictor determines that the data packet was lost due to data corruption.

41. A method for communicating data in a communication system, comprising the steps of:
(a) detecting a data packet loss;
(b) determining whether ECN compatible RED gateways are utilized within the communication system;
(c) selecting SpecTCP to generate instructions for recovery of the lost data packet including generating instructions for sizing a congestion window when ECN compatible RED gateways are utilized within the communication system; and
(d) selecting a legacy TCP congestion controller to generate instructions for recovery of the lost data packet including generating instructions for sizing or a congestion window when ECN compatible RED gateways are not utilized within the communication system.
